(19) United States
(12) Patent Application Publication
(10) Pub. No.: US 2006/0039024 A1
(43) Pub. Date: Feb. 23, 2006

(54) Information processing apparatus, system, and method

(75) Inventors: Hiroshi Iida, Kanagawa (JP); Satoshi Kaito, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/194,624

(22) Filed: Aug. 2, 2005

(30) Foreign Application Priority Data
Aug. 23, 2004 (JP) 2004-241736

(51) Int. Cl. G06K 15/00

(52) U.S. Cl. 358/1.14; 358/1.15

(57) ABSTRACT

There is provided an information processing apparatus including a producing portion producing instruction information to instruct a device to notify a result of a process, and a sending portion sending the instruction information that has been produced by the producing portion to the device. A destination to be notified of the result of the process varies depending on the result of the process.

### BACKGROUND OF THE INVENTION

1. Field of the Invention

This invention relates to an information processing apparatus, system, and information processing method and program.

2. Description of the Related Art

A sender, who has setup a transmission of image information, has some difficulty going to a receiver to see whether the image information has been transmitted normally. Conventionally, an apparatus has been proposed for informing the sender that the image information has been sent or informing the receiver that the image information has been received.

However, in recent years, the apparatus is equipped with different types of capabilities, and accordingly, there arises a problem in that an appropriate notification such as an error notification cannot be issued according to the apparatus.

### SUMMARY OF THE INVENTION

The present invention has been made in view of the above circumstances and provides an information processing apparatus, system, and information processing method and program, with which a destination of a result of a process to be notified by a device varies depending on the result of the process.

According to one aspect of the present invention, there may be provided an information processing apparatus including a producing portion that produces instruction information to instruct a device to notify a result of a process, and a sending portion that sends the instruction information produced by the producing portion to the device. A destination to be notified of the can be designated to the process. In accordance with the present invention, the instruction information is transmitted to notify the device of the result of the process. The result of the process may include error information.

According to another aspect of the present invention, there may be provided a system including a device notifying a result of a process to a given client terminal, and the above-mentioned information processing apparatus that instructs the device to notify the result. It is therefore possible to establish the system in which the destination to be notified by the device may vary depending on the result of the process.

According to a further aspect of the present invention, there may be provided an information processing method including producing instruction information to instruct a device to notify a result of a process, and sending the instruction information to the device. A destination to be notified of the result can be designed to the process.

### BRIEF DESCRIPTION OF THE DRAWINGS

Embodiments of the present invention will be described in detail based on the following figures, wherein:

FIG. 1 is a view of the whole structure of a system embodying the present invention;

FIG. 2 shows a configuration of a server 3 embodying the present invention;

FIG. 3 is a view illustrating a screen for setting the instruction on a notification of a result of a process;

FIG. 4 is an example of a template of error notification;

FIG. 5 shows a description example on an instruction file having instruction information on the notification of the result of the process; and

FIG. 6 is a flowchart describing the system operation embodying the present invention.

### DESCRIPTION OF THE EMBODIMENTS

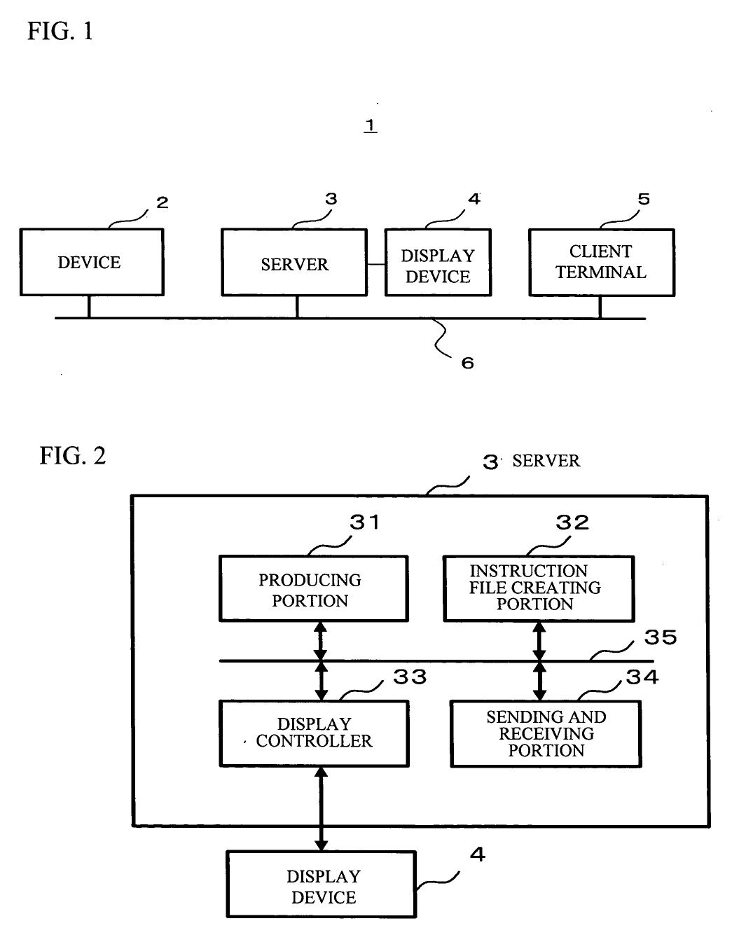

A description will now be given, with reference to the accompanying drawings, of embodiments of the present invention. FIG. 1 is a view of the whole structure of a system embodying the present invention. Referring to FIG. 1, a system 1 includes a device 2, a server 3, a display device 4, and a client terminal 5, which are connected through a network 6. The device 2 is composed of a complex machine having scan capabilities, transfer capabilities, facsimile send and receive capabilities, copy capabilities, and the like, and issues a notification of a result of a process including an error notification to the client terminal 5.

The server 3 instructs the device 2 to issue the notification of the result of the process. The server 3 is capable of designating what the device 2 processes with an instruction file, and is also capable of setting the instruction file in the device 2. A personal computer or mobile telephone may be employed for the server 3, because the server 3 just instructs the device 2 to issue the notification of the result of the process.

The display device 4 displays the result on the screen according to image signals transmitted from the server 3. The client terminal 5 receives the notification of the result of the process from the server 3 by e-mail, for example. The client terminal 5 is composed of a personal computer, mobile terminal, or the like.

Next, a description will be given of the server 3. FIG. 2 shows a configuration of the server 3 embodying the present invention. Referring to FIG. 2, the server 3 includes a producing portion 31, an instruction file creating portion 32, a display controller 33, and a sending and receiving portion 34, which are connected through a bus 35. The producing portion 31 produces instruction information to instruct the device 2 to notify the result of the process, the device 2 being provided for notifying the result of the process. The instruction, which is given by the producing portion 31 to notify the result of the process, includes, for example, a destination that the result of the process is to be notified, a notification content of the result of the process, or error information on the process made by the device 2. The producing portion 31 may produce the instruction information so as to instruct the device 2 to notify the result of the process, whenever the device 2 performs a process.

The instruction file creating portion 32 creates the instruction file describing the process of the device 2. The device 2 performs the process according to the description in the instruction. Multiple instruction files may be set up in the device 2. Additionally, multiple processes may be described in one instruction file. The producing portion 31 describes the instruction information on the notification of the result of the process in the instruction file created by the instruction file creating portion 32.

The display controller 33 controls display on the display device 4. For example, the display controller 33 displays a screen for determining whether or not the result of the process is notified, another screen for designating the destination the result of the process is notified of, still another screen for designating the notification content of the result of the process, yet another screen for designating the error information on the result of the process of the device 2, or further another screen for setting the instruction content in the notification such as the screen for designating an attribute to be determined according to the state of the device 2. Moreover, the display controller 33 is capable of designating an error notification in detail through the screen displayed by the display controller 33. For example, the error notification is not issued, if the process is cancelled in the device 2. The error notification is issued, if the device 2 malfunctions. The error notification is not issued, if the device 2 forwards or does not know where to send.

In addition to the above-mentioned respective designations in detail, error levels may be determined to designate whether or not the error notification is issued on the basis of the error level. For example, three levels such as error, warning, and information may be provided and selected. The message may be varied depending on the definition of the error at the time of generating the error. For example, three types of messages for error, warning, and information may be respectively and separately determined. The error definition in the process of the device 2 may be dynamically obtained from the device 2 and used after setting. The sending and receiving portion 34 sends the instruction information on the notification of the result of the process produced by the producing portion 31, to the device 2.

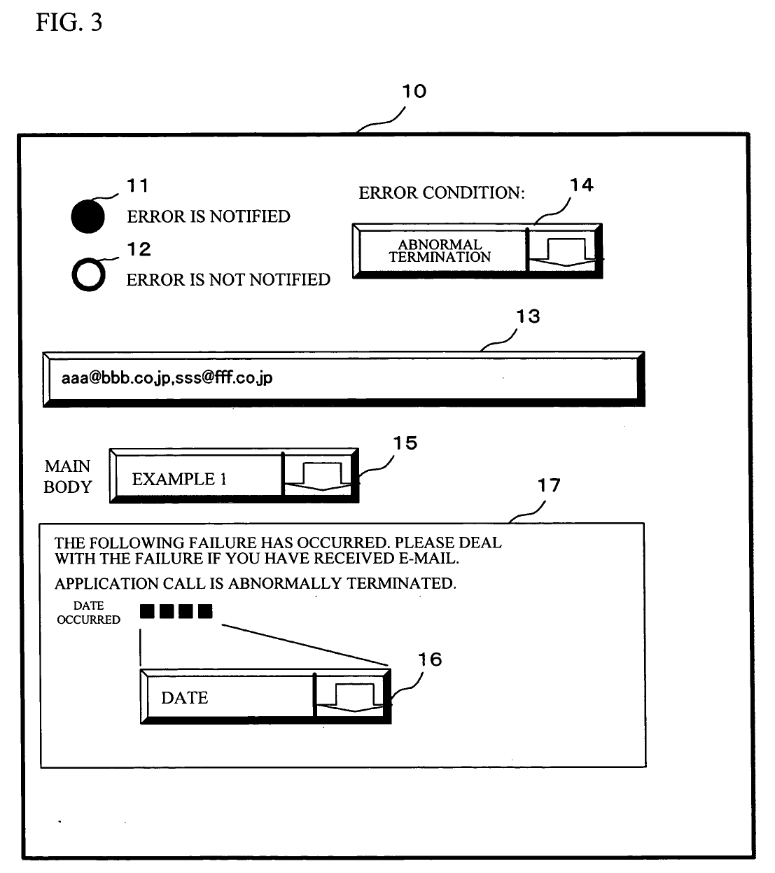

Next, a description will be given of the screen for setting the content of the instruction on the notification of the result of the process. FIG. 3 is a view illustrating the screen for setting the instruction on the notification of the result of the process. Referring to FIG. 3, the display controller 33 displays a screen 10 on the display device 4 so as to set the content of the instruction on the notification of the result of the process. Check boxes 11 and 12 are displayed for inputting whether the notification on the result of the process is to be issued. A box 13 is displayed for designating the destination the result of the process is sent to. A pull-down menu 14 is displayed for designating the error information on the result of the process of the device 2. Here, an error notification condition is exemplified to be used for determining whether the device warns an error according to the error level as the error information. The error information includes the content of the error occurred and the error level serving as a guide of the critical level, as described above. Another pull-down menu 15 is displayed for designating the content in the notification of the result of the process.

By choosing one of the check boxes 11 and 12, the user is able to choose whether or not the error notification is to be issued. Inputting an e-mal address in the box 13 enables to designate the destination to which the error notification is to be issued. Entering multiple e-mail addresses into the box 13 makes it possible to designate multiple addresses to be notified. The e-mail address is input as an example of the error notification according to the present embodiment, yet another method may be employed for issuing the error notification. The destination where the error notification is to be issued may vary depending on the method.

The error information can be designated with the pull-down menu 14. Abnormal termination is selected as the error notification condition in the example shown in FIG. 3. The device 2 issues the error notification according to the error information designated by the pull-down menu 14. For example, if the abnormal termination is designated, the device 2 issues the error notification at the time of abnormal termination. A template of the error notification can be designated with the pull-down menu 15.

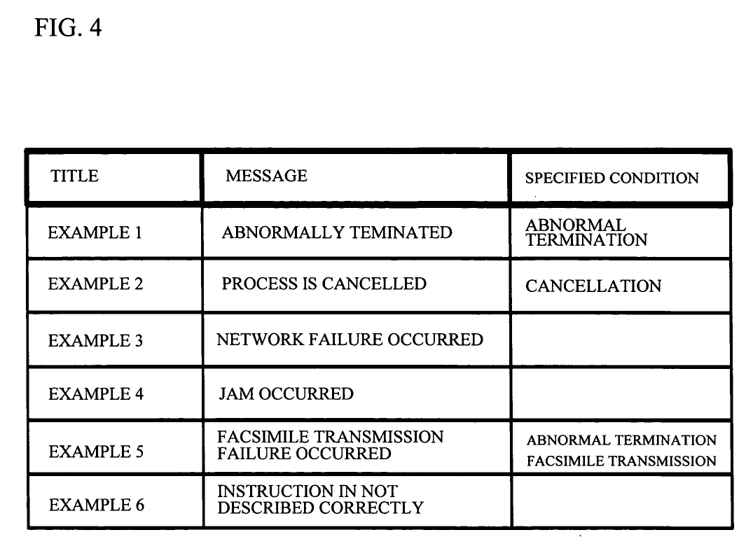

FIG. 4 is an example of the template of the error notification. Referring to FIG. 4, there are provided messages as the template of the error notification, such as “abnormally terminated” at the time of abnormal termination, “the process is cancelled” at the time of cancellation, “network failure occurred”, “jam occurred”, “facsimile transmission failure occurred” at the time of abnormal termination of the facsimile transmission, and “the instruction file is not described correctly”. The aforementioned template can be selected with the pull-down menu 15. The main body of the selected error notification is displayed in a box 17. The user is able to change or input the main body of the error notification with, for example, a keyboard. In this manner, the message of the error notification can be set when the instruction is set. If the message is not designated specially, a default message is selected to correspond to the process.

The attribute to be assigned can be designated with a pull-down menu 16. The information is input through the screen 10 to set the instruction on the notification of the result of the process, and is sent to the producing portion 31 by way of the display controller 33. The producing portion 31 embeds the information that has been input through the screen 10 for setting the instruction on the notification of the result of the process, into the instruction file that has been created by the instruction file creating portion 32. Here, the notification of the result is configured to be issued on the basis of the information that has been input through the screen 10 on which the instruction is set to notify the result. However, the producing portion 31 is able to automatically instruct the notification of the result according to the device 2. In addition to FIG. 3, another screen may be displayed for designating the attribute to be determined according to the state of the device 2. The attribute to be determined according to the state of the device 2 includes a state of toner, a state of tray, a type of facsimile communications line, a state of network, a date, or the like.

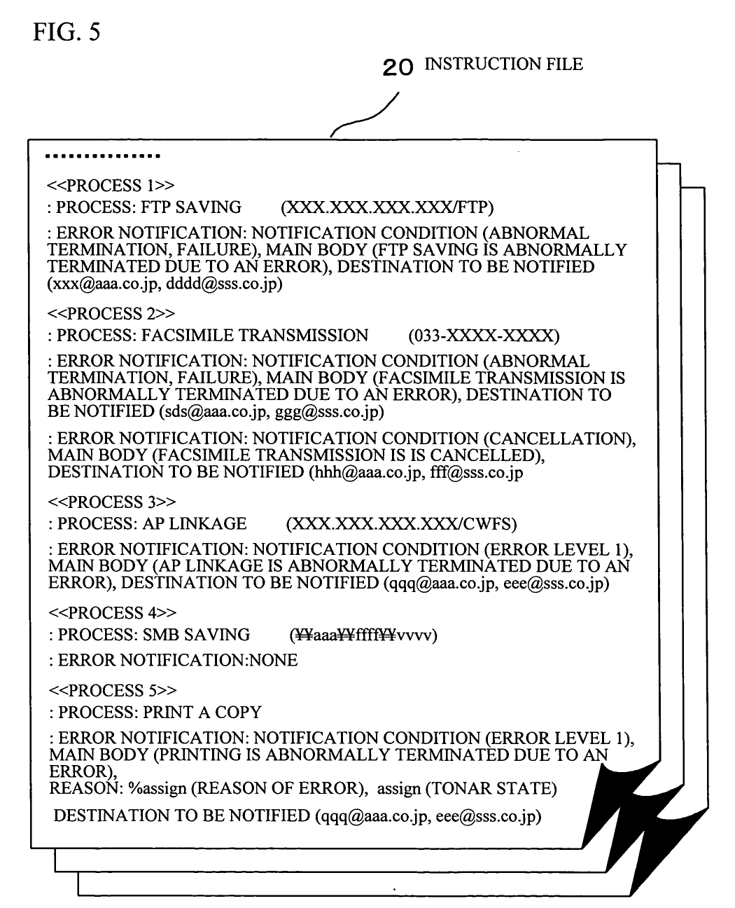

A description will now be given of a description example of the instruction file on the notification of the result. FIG. 5 shows a description example on the instruction file having the instruction information to notify the result. A first sheet of an instruction file 20 describes a process 1 through a process 5. Each process includes the error notification condition (notification condition), the main body (content of the notification of the result), and the destination to which the error is to be notified. With respect to the process 1, the device 2 transmits the error notification having the main body of “FTP saving is abnormally terminated due to an error”, to the destination to be notified as the error notification, if the abnormal termination of the failure occurs at the time of processing the FTP saving.

With respect to the process 2, the device 2 transmits the error notification having the main body of “Facsimile transmission is abnormally terminated due to an error”, to the destination to be notified as the error notification, if the abnormal termination of the failure occurs at the time of transmitting a facsimile. With respect to the process 3, the device 2 transmits the error notification having the main body of “AP linkage is terminated due to an error”, to the destination to be notified as the error notification, if the error level is 1 at the time of processing the application (AP) linkage.

With respect to the process 4, the device 2 does not issue the error notification, even if the error occurs at the time of saving SMB (Server Message Block). With respect to the process 5, the device 2 transmits the error notification having the main body of “Printing is terminated due to an error. Reason: % assign (reason of error), assign (the state of toner)”, to the destination to be notified as the error notification, if the error level is 1 at the time of printing a copy. With respect to all the processes described in the instruction file 20, a unified error message may be set. Also, the multiple processes described in one instruction file may be designated respectively whether or not the error notification is to be issued.

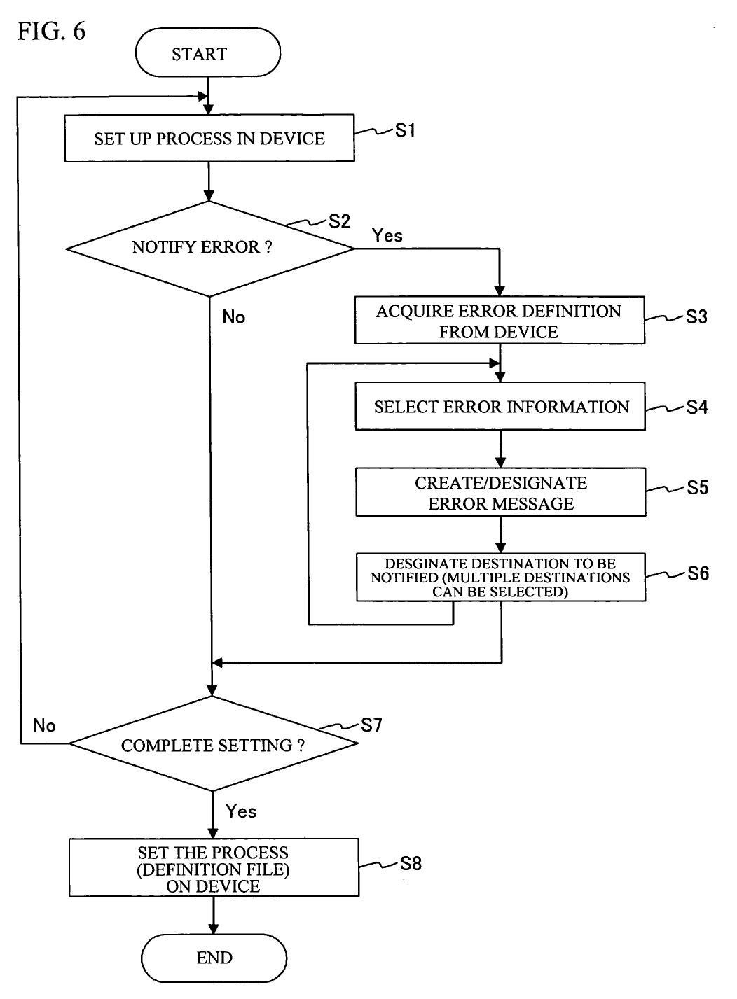

A description will be given of a system operation embodying the present invention. FIG. 6 is a flowchart describing the system operation in accordance with the present invention. The instruction file creating portion 32 creates the instruction file 20 designating the process of the device 2 and sets up the process in the device 2, in step S1. The user determines whether the error notification is to be issued while looking at the screen 10 on which the instruction is set for the notification of the result of the process shown in FIG. 3, in step S2. If the error notification is not to be issued, mark the check box 12 and go to step S7. If the error notification is to be issued, mark the check box 11 and go to step S3.

The display controller 33 acquires the error definition from the device 2 connected to the network 6 by way of the sending and receiving portion 34, in step S3. This error definition may be registered on the server 3 in advance. The display controller 33 displays the screen to select the error information in the pull-down menu 14, according to the error definition of the device 2. The user selects the error information with the pull-down menu 14 in step S4. The display controller 33 displays the pull-down menu 15 and the box 17, with which the notification of the result (error message) can be created or designated, on the display device 4.

The user is able to designate the error message by selecting the template of the main body from the pull-down menu 15, in step S5. Additionally, the user is able to change the main body displayed in the box 17, and is also able to input the main body in the box 17 directly. The destination to which the result of the process is to be notified is designated by inputting the e-mail address in the box 13 as the destination the result to be notified, in step S6. If the destination to be notified is not designated, the destination to be notified set in the device 2 is automatically selected. Multiple destinations to be notified can be set by repeating the process from step S4 through S6.

The information that has been input by way of the screen 10, which is used for setting up the instruction on the notification of the result, is input into the producing portion 31. The producing portion 31 embeds the information that has been input through the screen 10, which is provided for setting the instruction on the notification of the result, into the instruction file that has been created by the instruction file creating portion 32, and the setting is completed in step S7. The sending and receiving portion 34 sends the instruction file, in which the instruction information on the notification of the result is described, to the device 2, and the process, namely, a definition file, is set up on the device 2.

The present embodiment has the following effects. Conventionally, the e-mail address has been used as the destination and set up in the user interface of the device as a unified address. Therefore, the address cannot be changed according to the result. Moreover, if the facsimile send and receive report is transmitted by e-mail, the notification cannot be changed according to the state of the device, resulting in that the user receives various types of e-mail and finds it difficult to receive the desired e-mail notifying the error only.

The present embodiment makes it possible to designate the destinations individually on the device according to the result of the process described in the instruction file. The error notification can be designated according to the process whether or not the error notification is to be issued, if multiple processes are designated. Additionally, the error message can be designated according to the error notification set up for the process, if multiple processes are designated. Further, a group of the multiple processes can be designated according to the type or level of the error, whether or not the error notification is to be issued.

On the information processing apparatus in the above-mentioned aspect, the instruction information may include at least one of error information on the destination to be notified of the result, a content of notification of the result, and a process of the device. The aforementioned error information may include the content of the error, the error level as a rough standard of seriousness, the error notification condition to be used for determining whether the device warns an error according to the error level as the error information, for example. This makes it possible to instruct the device to notify the destination of the result, the content of the notification of the result of the process, and the error notification condition.

The information processing apparatus in the above-mentioned aspect may further include a display controller displaying a screen to designate whether or not the result of the process is to be notified. It is therefore possible to determine whether or not the result of the process is to be notified.

The information processing apparatus in the above-mentioned aspect may further include a display controller displaying a screen to designate at least one of the error information on the destination to be notified of the result of the process, the content of notification of the result of the process, and the process of the device. It is therefore possible to instruct the device to notify the destination of the result of the process and the content of the notification of the result of the process.

An information analysis method of the present invention is realized with a CPU (Central Processing Unit), ROM (Read Only Memory), RAM (Random Access Memory), and the like, by installing a program from a portable memory device or a storage device such as a hard disc device, CD-ROM, DVD, or a flexible disc or downloading the program through a communications line. Then the steps of program are executed as the CPU operates the program. An information processing method may include producing instruction information to instruct a device to notify a result of the process, and sending the instruction information that has been produced by the producing portion to the device. The producing portion 31 corresponds to a producing portion, the sending and receiving portion 34 corresponds to a sending portion, the instruction file creating portion 32 corresponds to a creating portion, the server 3 corresponds to an information processing apparatus, and the device 2 corresponds to the device.

Although a few embodiments of the present invention have been shown and described, it would be appreciated by those skilled in the art that changes may be made in these embodiments without departing from the principles and spirit of the invention, the scope of which is defined in the claims and their equivalents.

The entire disclosure of Japanese Patent Application No. 2004-241736 filed on Aug. 23, 2004 including specification, claims, drawings, and abstract is incorporated herein by reference in its entirety.

What is claimed is:

1. An information processing apparatus comprising:
a producing portion that produces instruction information to instruct a device to notify a result of a process; and
a sending portion that sends the instruction information produced by the producing portion to the device,
wherein a destination to be notified of the result can be designated to the process.

2. The information processing apparatus according to claim 1, further comprising a creating portion that creates an instruction file that indicates a process to be processed by the device.

3. The information processing apparatus according to claim 1, further comprising a creating portion that creates an instruction file that indicates a process to be processed by the device,
wherein the producing portion produces the instruction file including the instruction information.

4. The information processing apparatus according to claim 1, wherein the producing portion produces the instruction information for each process of the device.

5. The information processing apparatus according to claim 1, wherein the producing portion produces the instruction information to send the result to a plurality of destinations to be notified.

6. The information processing apparatus according to claim 1, wherein the instruction information includes at least one of the destination to be notified of the result, a content of notification of the result, and error information of the process of the device.

7. The information processing apparatus according to claim 1, further comprising a display controller that controls a screen to designate whether or not the result is to be notified.

8. The information processing apparatus according to claim 6, further comprising a display controller that controls a screen to designate at least one of the destination to be notified of the result, the content of the notification of the result, and the error information of the process of the device.

9. The information processing apparatus according to claim 1, wherein the destination to be notified of the result is described as an e-mail address.

10. A system comprising:
a device that notifies a result of a process to a client terminal; and
an information processing apparatus that instructs the device to notify the result,
wherein the information processing apparatus includes a producing portion that produces instruction information to instruct the device to notify a result of a process; and a sending portion that sends the instruction information produced by the producing portion to the device.

11. An information processing method comprising:
producing instruction information to instruct a device to notify a result of a process; and
sending the produced instruction information to the device,
wherein a destination to be notified of the result can be designated to the process.
